(19) United States
(12) Patent Application Publication
(10) Pub. No.: US 2007/0095177 A1
(43) Pub. Date: May 3, 2007

(54) Mounting apparatus for an electric saw

(76) Inventor: Joseph Iannelli SR., St. Cloud, FL (US)

Correspondence Address: ROBERT M. MCDERMOTT, ESQ., 1824 FEDERAL FARM ROAD, MONTROSS, VA, 22520, US

(21) Appl. No.: 11/261,163

(22) Filed: Oct. 27, 2005

(51) Int. Cl. B23D 45/00

(52) U.S. Cl. 83/13; 83/471.3

(57) ABSTRACT

A mounting apparatus for an electric saw includes a base having an aperture designed to receive a saw blade and one or more mounting brackets for positioning a workpiece; a support arm attached to the base; and a cradle capable of supporting an electric saw attached to the support arm.

### FIELD OF USE

The present invention relates to electric saws and, more particularly, to a mounting apparatus for an electric saw.

### BACKGROUND OF THE INVENTION

Over the years various electric saws have been mounted to tables and other structures. Typically, the electric saw is mounted in the inverted position in an opening of a saw table. The shoe of the electric saw is substantially in the plane of the saw table with the operative portion of the circular saw and the related guard projecting upwardly so that the sawing operation may be performed by moving the work piece across the top of the saw table. However, the table or other structure to which the saw is mounted typically limits the electric saw to a standard cut pursuant to the type of saw employed which then also dictates the angle(s) or range of angles at which the work piece may be mounted and cut.

Consequently, there exists a need for a mounting apparatus for an electric saw that permits the saw to cut workpieces at various angles.

### SUMMARY OF THE INVENTION

In accordance with the present invention, a mounting apparatus for an electric saw broadly comprises a base having an aperture designed to receive a saw blade and one or more mounting brackets for positioning a workpiece; a support arm attached to the base; and a cradle capable of supporting an electric saw attached to the support arm.

In accordance with the present invention, a method for sawing a workpiece at multiple angles broadly comprises loading an electric saw within the mounting apparatus of claim 1; positioning one or more mounting brackets of the mounting apparatus; positioning a workpiece along the one or more mounting brackets; and cutting the workpiece at one or more angles relative to the electric saw.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a representation of a mounting apparatus of the present invention for an electric saw;

FIG. 2 is another representation of the mounting apparatus of FIG. 1; and

FIG. 3 is another representation of the mounting apparatus of FIG. 1.

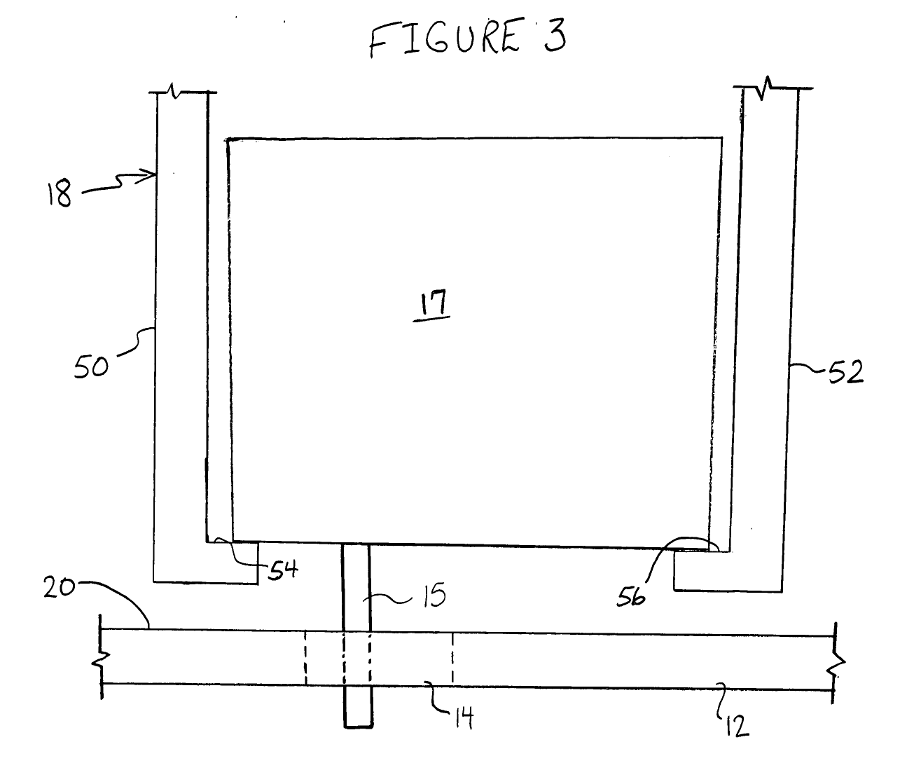

Like reference numbers and designations in the various drawings indicate like elements.

### DETAILED DESCRIPTION

A mounting apparatus for an electric saw and a method of cutting a workpiece using an electric saw mounted with the apparatus are disclosed herein. The mounting apparatus permits an operator to place a workpiece upon a working surface at various angles relative to a saw blade of the electric saw. By allowing an operator such flexibility, the electric saw possesses the ability to cut a workpiece as if using one of three different saws, for example, a skill saw, a table saw and a miter saw. As will be recognized by one of ordinary skill in the art, skill saws are not designed in order to perform trim work. However, the mounting apparatus of the present invention facilitates using a skill saw to perform trim work. One or more mounting brackets disposed on a working surface of the mounting apparatus permit the operator to effectively mount a skill saw, position a workpiece using the mounting brackets and perform the trim work.

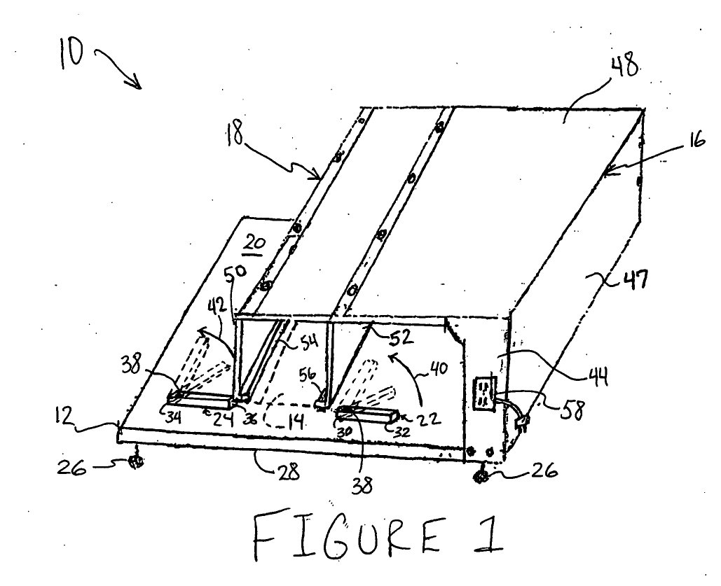

Referring now to FIG. 1, a mounting apparatus 10 may comprise a base 12 having an aperture 14 designed to receive a saw blade 15 of an electric saw 17. A support arm 16 having a cradle 18 attached thereto may be mounted to the base 12. The cradle 18 is capable of support the electric saw. To position a workpiece (not shown) upon a working surface 20 of the base 12 one or more mounting brackets 22, 24 may be mounted to the working surface 20.

The mounting apparatus 10 may comprise any material suitable for holding and supporting an electric saw. Suitable materials may include, but are not limited to, wood, plastics, metals and their alloys, combinations comprising at least one of the foregoing materials, and the like. The mounting apparatus 10 may stand alone or may be incorporated into a static structure such as, but not limited to, a table, work bench, and the like. The mounting apparatus 10 may be manually operated or mechanically controlled by an operator using a computer. If mechanically controlled, the mounting apparatus 10 may be incorporated into a machine utilizing an open working environment, for example, a manufacturing plant floor, or a closed working environment, for example, a sealed enclosure.

The base 12 may also include a leveling mechanism 26 disposed on a bottom surface 28 of the base 12. The leveling mechanism 26 is designed to ensure the mounting apparatus 10 is level with a surface (not shown) upon which the apparatus 10 is placed. The leveling mechanism may comprise any means for leveling the apparatus 10 as known to one of ordinary skill in the art such as, but not limited to, mechanically implemented devices, manually implemented devices, combinations comprising at least one of the foregoing devices, and the like.

Each mounting bracket 22, 24 may be disposed on the working surface 20 of the base 12 and comprise a first end 30, 32 and a second end 34, 36. For example, a first mounting bracket 22 may be disposed on one side of the cradle 18 while a second mounting bracket 24 may be disposed on the opposing side of the cradle 18 and opposite the first mounting bracket 22. Either the first ends 30, 32 or the second ends 34, 36 of each mounting bracket 22, 24 may be secured to the working surface 20 by a removable fastener 38. Suitable removable fasteners 38 may include, but are not limited to, screws, bolts, punches, pins, combinations comprising at least one of the foregoing fasteners, and the like. Each mounting bracket 22, 24 may be capable of moving in a direction indicated by arrows 40, 42 along the working surface 20. Preferably, the mounting brackets 22, 24 may each move one hundred eighty degrees along the working surface 20.

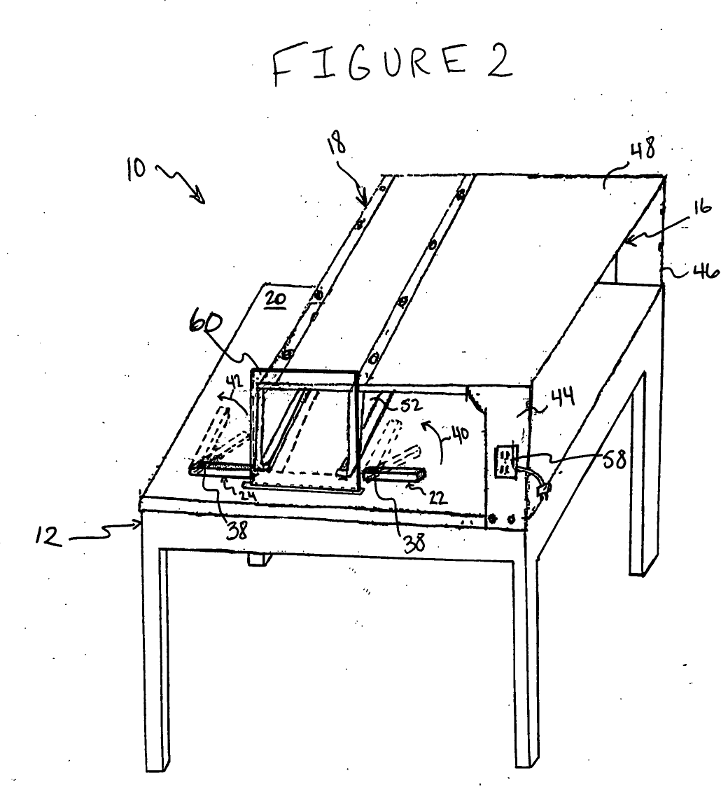

The support arm 16 may comprise a front wall 44 and a rear wall 46 mounted to the base 12. A cover 48 may be attached to the front wall 44 and rear wall 46. The cradle 18 may be attached to the underside or bottom surface of the cover 48 and suspended over the working surface 20 at a height sufficient to permit loading an electric saw into the cradle 18. Optionally, an additional sidewall 47 may be disposed between the front wall 44 and rear wall 46, and attached to the base 12 as illustrated in FIG. 2.

The cradle 18 may comprise a first sidewall 50 and second sidewall 52 disposed opposite each other and attached to the cover 48. Both the first sidewall 50 and second sidewall 52 extend toward and are suspended over the working surface 20 at a height sufficient to permit loading an electric saw into the cradle 18. The first sidewall 50 includes a first support ledge 54 that extends inwardly toward the second sidewall 52. Likewise, the second sidewall 52 includes a second support ledge 56 that extends inwardly toward the first sidewall 50. The first and second support ledges 54, 56 are designed to receive any conventional electric saw known to one of ordinary skill in the art. It is contemplated that the mounting apparatus 10 and its components may be sized and dimensioned accordingly to receive electric saws of various shapes and sizes as can be recognized by one of ordinary skill in the art. The cradle 18 may receive and suspend the electric saw above the working surface 20 at a distance sufficient to accommodate the workpiece.

To protect the safety of an operator a safety switch 58, or kill switch, may be included. The safety switch 58 permits the operator to instantly shut off the power to the electric saw. The electric saw is preferably plugged into an outlet (not shown) built into the mounting apparatus 10, which may be connected to the safety switch 58. The safety switch 58 may also include a connection to a power source (not shown), which enables the operator to interrupt the flow of electricity to the electric saw.

Referring now to FIG. 2, another safety feature of the mounting apparatus may comprise a shield 60 or a means for shielding an operator. The shield 60 or means for shielding may comprise, but is not limited to, any suitable transparent, impact resistant material known to one of ordinary skill in the art. The shield 60 may be mounted to the base 12, support arm 16, cradle 18 or a combination of these components in order to prevent the operator from being struck by airborne debris generated by cutting the workpiece.

As shown in FIG. 1, the mounting apparatus 10 may be a portable device and configured to rest upon any static structure. In the alternative, as shown in FIG. 2, the mounting apparatus 10 may also be part of a static structure such that the base 12 may be, for example, a table, and the like, capable of at least supporting the weight of the mounting apparatus 10, electric saw and one or more workpieces.

The mounting apparatus 10 permits an operator, for example, one of ordinary skill in the art, to place a workpiece upon the working surface 20 at various angles relative to the saw blade of the electric saw. By allowing an operator such flexibility, the electric saw possesses the ability to cut the workpiece as if using one of three different saws, for example, a skill saw, a table saw and a miter saw.

The method for sawing a workpiece at multiple angles as if using one of the three aforementioned saws may comprise loading an electric saw within the mounting apparatus. Once loaded, one or more mounting brackets 22, 24 are secured to the working surface 20 such that each mounting bracket 22, 24 may be moved about one hundred eighty degrees in a direction of arrows 40, 42 along the working surface 20 of the mounting apparatus 10. A workpiece may be positioned upon the working surface 20 and against one of the mounting brackets 22, 24 as determined by the operator. The workpiece may then be cut at one or more angles relative to the electric saw. As will be recognized by one of ordinary skill in the art, conventional electric saws allow the operator to manually adjust the angle of the saw blade such that the blade is disposed at angle to the working surface 20 rather than at a ninety degree angle. As a result, the mounting apparatus 10 would not only permit an operator to cut a workpiece at various angles while mimicking one of the aforementioned electric saws but also permit the operator to make an angled cut into the workpiece itself.

The mounting apparatus of the present invention permits the operator to place a workpiece upon the working surface at various angles relative to the saw blade. By allowing the operator such flexibility, the electric saw possesses the ability to cut the workpiece as if using one of three different saws, for example, a skill saw, a table saw and a miter saw. As will be recognized by one of ordinary skill in the art, skill saws are not designed in order to perform trim work. However, the mounting brackets permit the operator to effectively mount the skill saw, position the workpiece using the mounting brackets and perform the trim work.

It is to be understood that the invention is not limited to the illustrations described and shown herein, which are deemed to be merely illustrative of the best modes of carrying out the invention, and which are susceptible to modification of form, size, arrangement of parts, and details of operation. The invention rather is intended to encompass all such modifications which are within its spirit and scope as defined by the claims.

What is claimed is:

1. A mounting apparatus for an electric saw, comprising:
a base having an aperture designed to receive a saw blade and one or more mounting brackets for positioning a workpiece;
a support arm attached to said base; and
a cradle capable of supporting an electric saw attached to said support arm.

2. The mounting apparatus of claim 1, further comprising a means for leveling said base.

3. The mounting apparatus of claim 1, further comprising a safety switch for turning off a power source to said electric saw.

4. The mounting apparatus of claim 1, wherein said support arm comprises:
a front wall attached to said base;
a rear wall attached to said base; and
a cover attached to said sidewall and disposed over said base at a height sufficient to permit loading said electric saw into said cradle.

5. The mounting apparatus of claim 4, wherein said support arm further comprises a sidewall disposed between said front wall and said rear wall and attached to said base.

6. The mounting apparatus of claim 1, wherein said cradle further comprises:
a first sidewall attached to said cover and extending toward said base, said first sidewall comprises a first support ledge; and
a second sidewall attached to said cover and extending toward said base, said second sidewall comprises a second support ledge,
wherein said first sidewall and said second sidewall are disposed opposite each other,
wherein said first support ledge and said second support ledge are designed to receive said electric saw.

7. The mounting apparatus of claim 1, wherein said electric saw is suspended above said base by said cradle at a distance sufficient to accommodate said workpiece.

8. The mounting apparatus of claim 1, wherein said one or more mounting brackets comprise a bracket comprising a first end and a second end disposed on a surface of said base and capable of moving along said surface.

9. The mounting apparatus of claim 8, wherein either said first end or said second end of said bracket is mounted to said surface using a removable fastener.

10. The mounting apparatus of claim 8, wherein said one or more mounting brackets are capable of moving one hundred eighty degrees along said surface.

11. The mounting apparatus of claim 8, wherein said one or more mounting brackets comprise a first mounting bracket and a second mounting bracket, wherein said first mounting bracket and said second mounting bracket are disposed opposite each other and on opposite sides of said cradle.

12. The mounting apparatus of claim 1, wherein said base comprises a table.

13. The mounting apparatus of claim 1, wherein the mounting apparatus is portable.

14. The mounting apparatus of claim 1, further comprising a means for shielding an operator mounted to the mounting apparatus between said cradle and an operator.

15. The mounting apparatus of claim 14, wherein said means for shielding comprises a transparent, impact resistant material.

16. A method for sawing a workpiece at multiple angles, comprising:
loading an electric saw within the mounting apparatus of claim 1;
positioning one or more mounting brackets of the mounting apparatus;
positioning a workpiece along said one or more mounting brackets; and
cutting said workpiece at one or more angles relative to said electric saw.
